(19) United States
(12) Patent Application Publication
(10) Pub. No.: US 2003/0182283 A1
(43) Pub. Date: Sep. 25, 2003

(54) Data extraction system and method

(75) Inventors: Thomas A. Bean, West Columbia, SC (US); James L. Browning, Columbia, SC (US); Scott D. Carty, San Diego, CA (US); Tucker L. Smith, Irmo, SC (US)

Correspondence Address: JAMES M. STOVER, NCR CORPORATION, 1700 SOUTH PATTERSON BLVD, WHQ4, DAYTON, OH, 45479, US

(73) Assignee: NCR Corporation

(21) Appl. No.: 10/104,659

(22) Filed: Mar. 22, 2002

(51) Int. Cl. G06F 17/30

(52) U.S. Cl. 707/6

(57) ABSTRACT

One embodiment of the present invention relates to a system for extracting online data from a variety of web-sources in real-time and transmitting the data to a data warehouse in real-time. The system comprises an extractor plug-in having instructions configured to integrate with a pre-determined type of host server and extracting data in real-time from any variety of web source in communication with the host server. The system also comprises a transformer engine in communication with the extractor plug-in and configured to transmit the extracted data in real-time into a data warehouse for analysis thereof.

The present invention relates to a data extraction system and method, and more particularly to a system and method of extracting online data in real-time or in batch from a variety of web-sources.

### BACKGROUND OF THE INVENTION

The Internet has proliferated many new opportunities for companies selling products and services such as providing them the opportunity to expand their market presence all over the world. This presence has allowed many of these companies to not only increase revenue growth but also to expand product lines and services offered to online users. Due to increases in demand many of these companies have experienced, most typically devote a significant amount of resources to attract new and existing users to their online web-sites.

Nonetheless, in light of the successes many companies have experienced with online offerings, few have the data that identifies which users are most apt to not only visit their web-site, but also purchase and re-purchase products and services. This lack of data leaves companies feeling helpless with respect to effectively allocating resources to attract new and existing users to their online web-site. Accordingly, it is becoming increasingly common for companies that provide online services to capture and analyze online data to enhance the effectiveness of resources utilized to attract new and existing users to their online web-sites.

In particular, online data may be derived from many sources such as web logs maintained by a web server or even data collected from a user's current interaction with a web-site. Many companies would find it advantageous to enable the consistent and timely capture and storage of such online data in a data warehouse. More particularly, the data could be analyzed by a company and used to make critical business decisions regarding its online business strategy based on user activity related to the web-site.

Additionally, many companies might also find it advantageous to collect such data representing current user activity in real-time. Such real-time data may allow a business entity to provide enhanced personalization and content to users in communication with its web-site. Accordingly, the present invention seeks to address the above issues and provides a system and method for extracting online data from any variety of web-sources in real-time or in batch.

### SUMMARY OF THE INVENTION

One embodiment of the present invention is a system for extracting data from a variety of web-sources. The system comprises an extractor plug-in having instructions configured to integrate with a plurality of pre-determined types of host servers and extract data in real-time from a plurality of web sources in communication with the host server. The system also comprises a transformer engine in communication with the extractor plug-in and configured to transmit the extracted data into a data warehouse for analysis thereof.

Another embodiment of the invention is a system for extracting data from a variety of web-sources. In this embodiment, the system comprises a batch extractor comprising instructions configured to integrate with a plurality of pre-determined types of host servers and extract data in batch from a plurality of web sources in communication with the host server. The system further comprises a transformer engine in communication with the extractor and configured to transmit the extracted data in batch into a data warehouse for analysis thereof.

Yet another embodiment of the invention is a method of extracting data from a variety of web-sources. The method comprises the steps of identifying a type of web source in communication with a host server, selecting an extraction protocol based on the identified type of web source, and executing the extraction protocol to extract data from the web source.

Still other objects, advantages and novel features of the present invention will become apparent to those skilled in the art from the following detailed description, which is simply, by way of illustration, various modes contemplated for carrying out the invention. As will be realized, the invention is capable of other different aspects all without departing from the invention. Accordingly, the drawings and descriptions are illustrative in nature and not restrictive.

### BRIEF DESCRIPTION OF THE DRAWINGS

While the specification concludes with claims particularly pointing out and distinctly claiming the present invention, it is believed that the same will be better understood from the following description, taken in conjunction with the accompanying drawings, in which:

FIG. 1 is a block diagram depicting an illustrative embodiment of a data extraction system made in accordance with principles of the present invention;

FIG. 2 is a block diagram depicting an illustrative embodiment of a data extraction system in accordance with principles of one embodiment of the present invention;

FIG. 3 is another block diagram depicting an illustrative embodiment of a data extraction system in accordance with principles of the present invention;

FIG. 4 is another block diagram depicting an illustrative embodiment of a data extraction system in accordance with principles of the present invention; and

FIG. 5 is a data flow diagram depicting an illustrative data extraction method operating in accordance with principles of the present invention.

### DETAILED DESCRIPTION OF EXEMPLARY EMBODIMENTS

Reference will now be made in detail to various embodiments of the invention, various examples of which are illustrated in the accompanying drawings, wherein like numerals indicate corresponding elements throughout the views.

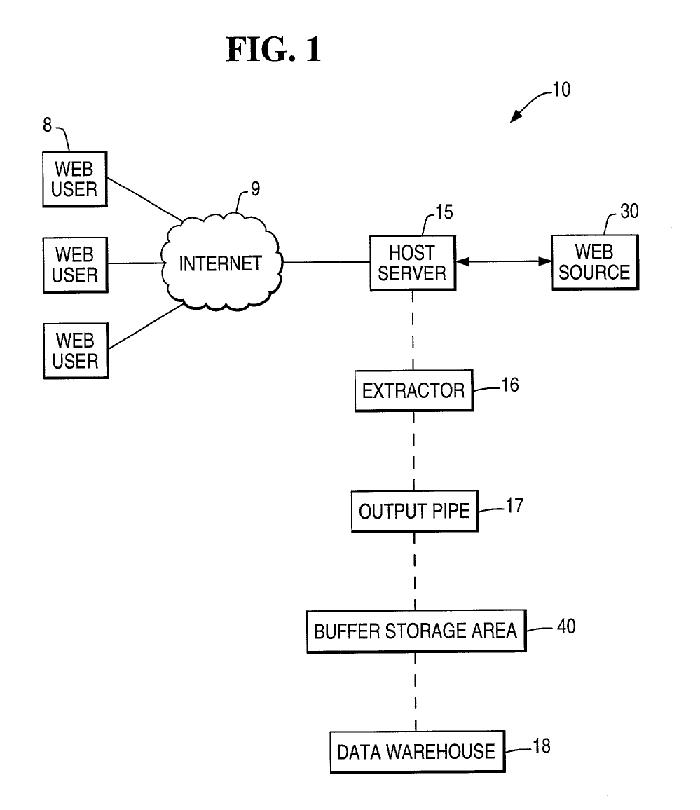

FIG. 1 is a block diagram depicting an illustrative embodiment of a data extraction system 10 made in accordance with principles of the present invention. The data extraction system 10 may be designed to, among other things, provide a robust and scalable solution capable of extracting online data, in real-time or in batch, from a variety of web-sources 30 and parallel load and integrate the extracted data into a data warehouse 18. To achieve optimum performance and robustness, communication between the components of the system 10 may be through a standard network communication technology such as asynchronous transfer mode.

It is typical for many companies to host one or more web-sites through a variety of host servers 15 such as a web-servers including a Microsoft Commerce Server, Microsoft Internet Information Server, an Apache server, Netscape Server and many others. In these circumstances, the host server 15 is typically configured to provide World Wide Web services such as serving up web pages or providing e-comrnerce functions to web users or users 8 in communication with the host server 15 through the Internet 9. In an exemplary embodiment of the invention, the host server 15 may comprise a multi-CPU Microsoft Windows NT/2000 server. Moreover, in the exemplary embodiment, the host server 15 may be configured with a Microsoft Windows NT/2000 operating system environment.

Web users 8, on the other hand, typically browse the Internet 9 using a web-browser in communication with a server in communication with the Internet 9. Once the user is linked to a host server 15 providing an online web-site, the host server 15 may not only create a web-log relating to the user's activity with respect to the web-site, but the host server may also be configured to communicate with the user's web-browser. The data extraction system 10, of the present invention, may be capable of extracting data from these two web-sources 30 in real-time or in batch to provide the business with a better idea of the users that are visiting its web-site. As should be recognized, such extracted online data can be analyzed in a data warehouse 18 by business entities collecting the data to make better business decisions relating to their online business strategies.

The online data extraction system 10 may comprise an extractor 16 configured to seamlessly integrate with a host server 15 and extract data from various web-sources 30 with which the system 10 interacts. As used herein, the term web-sources 30 is contemplated to mean any source of information generated by or containing web-data such as data from a user's web-browser or a web-log generated by a web-server. The data extracted by the extractor 16 from the various web-sources 30 may be transmitted to an output pipe 17 and/or buffer storage area 40 which may be configured to, among other things, receive, filter, tag and transmit the data to a data warehouse 18 for analysis thereof. It should be recognized that the online data extracted from the variety of web-sources 30 can be analyzed, transmitted and stored in a data warehouse 18 to allow companies to make better decisions with respect to their online business strategies.

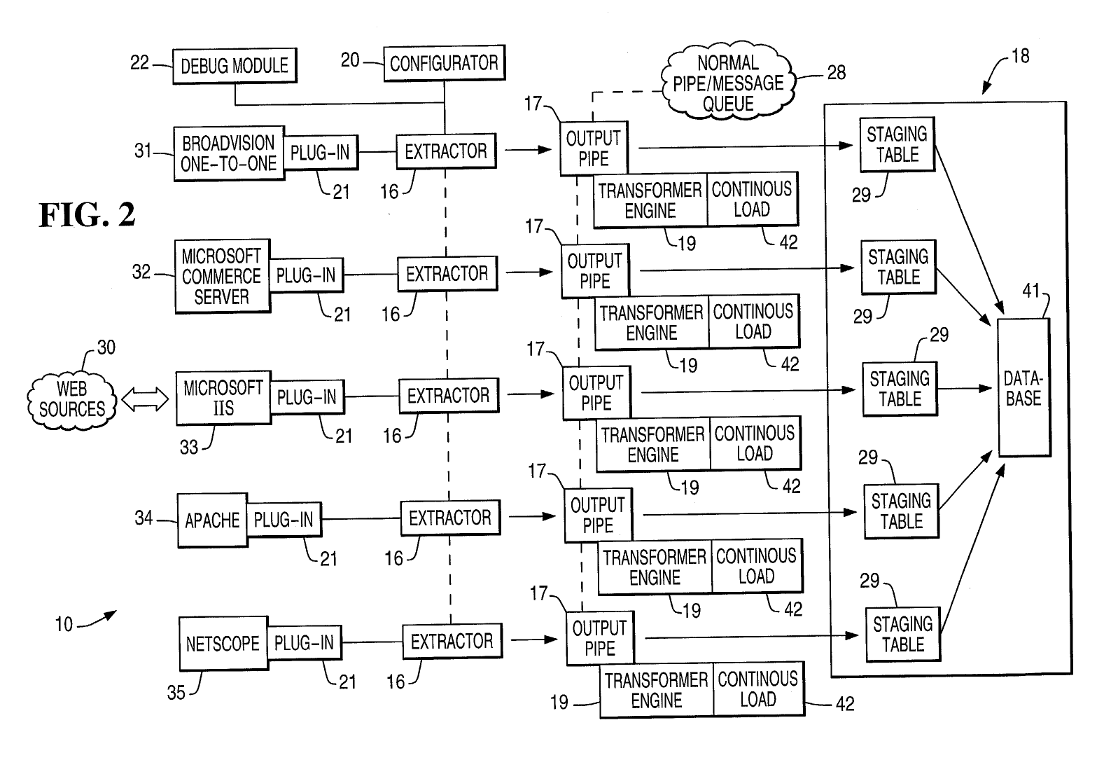

FIG. 2 is a block diagram depicting an illustrative embodiment of a data extraction system 10 in accordance with principles of one embodiment of the present invention wherein an online data extraction system 10 is configured to extract online data from a variety of web-sources 30 in real-time and configured to transmit the data to a data warehouse 18 in real-time. As used herein, the term real-time is contemplated to mean data transmitted or extracted as the user interacts with the host server 15. In other words, data representing a user's interactions with a host server 15 via a web-browser may be extracted, transmitted and stored in a data warehouse 18. It is contemplated that such data may also be analyzed in real-time to provide the business entity with an opportunity to provide real-time enhancements to content made available to a user browsing the website.

In the embodiment illustrated in FIG. 2 of the present invention, the extractor 16 comprises a plug-in 21 configured to seamlessly integrate with any variety of host servers 15 for extracting data from any variety of web-source 30. For example, the plug-ins 21 may be designed to seamlessly integrate with any type of host server such as a BroadVision One-to-One server 31, Microsoft Commerce Server 32, Microsoft IIS 33, Apache server 34, a Netscape server 35 or any other type of server. In particular, it is contemplated that the initial plug-in 21 embodiment may be configured to seamlessly integrate with a Microsoft IIS web server 33 with additional plug-in environments to be subsequently developed. This allows the business entity to support multiple types of host servers 15 within the enterprise and seamlessly and in real-time extract data from any variety of web-sources 30.

In this embodiment, the plug-ins 21 are configured to extract data from web-sources 30 using standard application programming interfaces (APIs). However, as one of skill in the art may recognize, it may also be feasible to design the plug-ins 21 with custom extraction logic. In particular, in one embodiment of the invention, the plug-ins 21 may comprise a variety of extraction protocols, such as executable instructions, configured to identify any variety of web source 30 format. Once the extractor identifies a particular type of web source 30 format, the extractor might select the appropriate extraction protocol to extract data from the web source 30.

In an exemplary embodiment of the invention, the plug-ins 21 should be designed to be operating system independent so the plug-ins 21 are compatible with virtually any type of host server system 15. Additionally, it should be recognized that the extractor plug-ins 21 may be configured to run in parallel, so as to impose no practical limit on the number of host servers 15 that can exist within a business enterprise. Accordingly, the data extraction system 10 may be configured to support multiple types of host server 15 formats within a business enterprise.

The extractor plug-ins 21 may also be configured to impose only a minimal performance impact on the host server 15 because all filtering, transformation and data manipulation is configured to be performed on other components of the system 10 such as in the data warehouse 18. While performance impact may vary, in one illustrative embodiment of the invention, the extractor plug-ins 21 impose no more than a 3% performance impact on a host server 15.

As further illustrated in FIG. 2, the data extraction system 10, may further comprise an output pipe 17 configured to receive extracted data transmitted by the one or more plug-ins 21 integrated into the host servers 15. In this embodiment of the invention, it is contemplated that the output pipe 17 comprises either named pipes or IBM message queues 28 and that the data may be written to the named pipe/message queue 28 in the format of the host server 15 environment. The various host environments may each have an assigned data format matching a staging table 29 format in a data warehouse 18 to allow data to be transmitted and stored in the data warehouse 18.

In the exemplary embodiment of the invention depicted in FIG. 2, the output pipe 17 may be serviced by a transformer engine 19 configured to transmit the data from the output pipe 17 to the data warehouse 18. The term “transformer engine” is contemplated to mean software code or instructions configured to transmit data between the various components of the system 10. In this exemplary embodiment, a continuous load utility such as TPump, as available from NCR Corporation, may be used to transmit extracted data from the output pipe 17 to the data warehouse 18. It should be recognized that virtually any type of transformer engine 19 may be used to service the output pipe 17, but in this exemplary embodiment, Tpump is contemplated because it allows the continuous transmission of data in real-time.

In this embodiment of the invention, the plug-ins 21 may write content to an output pipe 17 serviced by the transformer engine 19, which in-turn writes the extracted online data to a data warehouse 18 in real-time. In this way, online data may be extracted from any variety of web-sources 30 in real-time via the extractor plug-ins 21 and transmitted and loaded into a data warehouse 18 in real-time via the transformer engine 19. Accordingly, real-time data can be extracted and transmitted to a data warehouse 18 for analysis, thereby making it possible for the host business entity to analyze the data and provide real-time personalized web-pages to any web-user in communication with the system.

As further illustrated in FIG. 2, the online data extraction system 10 may comprise a configurator 20 in communication with the plug-ins 21. In an exemplary embodiment of the invention, the configurator 20 is contemplated to be software code or instructions configured to be a graphical user interface (GUI) for configuration/management of the data extraction system 10. In particular, it is contemplated that the configurator 20 may provide the business entity with an easy and intuitive tool for configuration and operation of the data extraction system 10 and in an exemplary embodiment of the invention may be configured to run as a Windows GUI application in a Microsoft Windows NT/2000 environment.

The configurator 20 may comprise instructions that allow the business entity to set configurable parameters, perform data content filtering, perform domain name space updates on data stored in staging tables, perform in-warehouse transformations of data from staging tables to warehouse tables, and allow warehouse data cleaning based on user specified filters including wild-card use. In this embodiment, the configurator 20 may allow parameters to be configured for the plug-ins 21, may allow the business entity to setup and configure the named pipe/message queue 28 for use by plug-ins 21 and may accept configuration information relating to data load methodology and warehouse access information. Moreover, the configurator 20 may provide visual feedback regarding progress during in-warehouse transformation and domain name system lookup functions.

Additionally, in an exemplary embodiment of the invention, the data extraction system 10 might be provided with a debug module 22 in communication with the extractors 16. It is contemplated that a debug module might collect operation metrics that relate to system use and might provide statistics on the operational metrics. The debug module may also allow users to maintain, update and debug the data extraction system 10.

Lastly, it is contemplated that a data warehouse 18 may be in communication with an output pipe 17 to receive data transmitted by the transformer engine 19. As may be known in the art, the data warehouse 18 may comprise predetermined staging tables 29 configured to receive data based on format type. The staging table formats may be determined by the type of web-source from which the data was extracted. Data from the staging tables 29 may then be integrated into a physical database 41 which allows the data to be manipulated and analyzed by the host entity. Data in the data warehouse 18 may be modified and updated using standard SQL language.

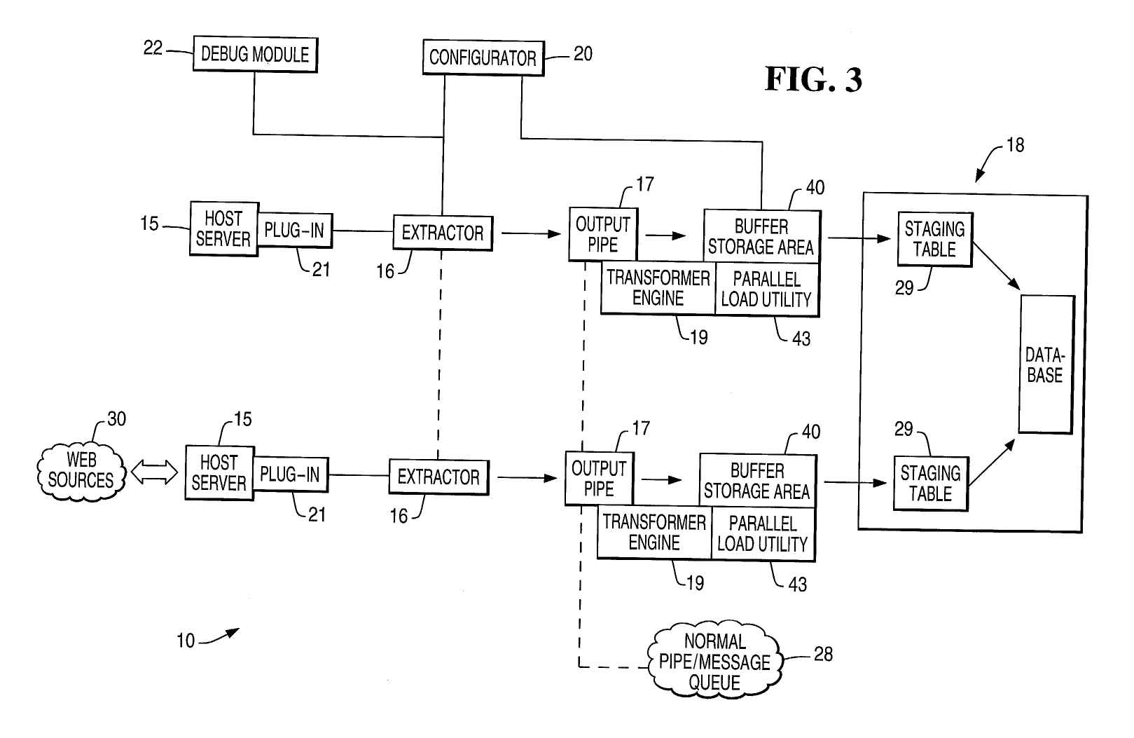

FIG. 3 depicts another exemplary embodiment of the present invention wherein data may be extracted from the web-sources 30 in real-time and batch loaded into a data warehouse 18. It should be recognized from the foregoing that providing both real-time extraction and real-time transmission of data to a data warehouse 18 may unduly tax the available resources of a host network system. Accordingly, in some circumstances, it may not be possible or practicable to both extract and transmit data to a data warehouse 18 in real-time.

In these circumstances, data may be extracted in real-time, but transmitted to a data warehouse 18 in batch as depicted in FIG. 3. In this situation, a host server 15 may be able to extract desired data from a user's interaction with the host server 15 and temporarily store the data in a buffer storage area 40. At the server's convenience, the data could then be transmitted in batch to a data warehouse 18. In this way, the host server 18 may extract and collect data in real-time to provide the host entity with data desired and may also provide a method of transmitting the data to a data warehouse 18 without over extending the resources of the host entity's network.

In the embodiment of FIG. 3, the data extraction system 10 may comprise many of the same components as described in FIG. 2, including at least one plug-in 21, an output pipe 17, a configurator 20 and a data warehouse 18. In this embodiment, the data extraction system 10 may further comprise a buffer storage area 40 that provides temporary storage for data to be written to the data warehouse 18.

The plug-ins 21 of FIG. 3 are the same as those previously described in FIG. 2 and the output pipe 17 may be, once again, serviced by a transformer engine 19. However, in this embodiment, the plug-ins 21 write their content to an output pipe 17 serviced by the transformer engine 19, which then writes the extracted online data to a buffer storage area 40 and then to a data warehouse 18. In this way, online data may be extracted from any variety of web-sources 31 in real-time via the plug-ins 21, but transmitted and loaded into a data warehouse 18 in batch via the transformer engine 19. Accordingly, real-time data can be extracted and subsequently transmitted to a data warehouse 18 in batch, thereby allowing the desired data to be extracted and stored in a data warehouse for analysis thereof.

The transformer engine 19 may be configured to read extracted data from an output pipe 17, such as a named pipe/message queue 28. The transformer engine 19 may analyze the data in the output pipe 17 and determine an appropriate buffer storage area 40 based on the extracted data type. For example, data extracted from the various web-sources 30 may be of various configurations. Accordingly, data may be transmitted to an appropriate buffer storage area 40 based on the type of data. In an exemplary embodiment of the invention, data format information may be configured to be the first character of the information stored in the named pipe/message queue 28.

The transformer engine 19 may not only manage the buffering of extracted data to the buffer storage area 40, but the transformer engine 19 may also provide an interface to a parallel loading utility 43 for scheduled data loading into the data warehouse 18. In particular, the transformer engine 19 in this embodiment may write data from the buffer storage area 40 to the appropriate data warehouse staging tables 29 at pre-configured intervals using a parallel load utility 43 such as FastLoad as available from NCR Corporation. Once again, virtually any type of transformer engine 19 may be used to service the output pipe 17 and the buffer storage area 40, but in an exemplary embodiment of the invention, FastLoad is contemplated because it allows large amounts of data to be easily handled and transmitted.

In addition, in this embodiment, it is contemplated that the transformer engines 19 may be configured to run in parallel and be independent of each other so as to impose no fixed limit to the number of transformer engines 19 that can be configured and run in a network environment. Each transformer engine 19 may also be multi-threaded to allow multiple threads to process information from its assigned named pipe/message queue 28. In an exemplary embodiment of the invention, the transformer engine 19 may be configured to run within a Microsoft Windows NT/2000 environment. Alternate server environments for the transformer engine 19 may be later developed, such as compatibility with UNIX.

The data extraction system of FIG. 3 may also comprise a configurator 20 in communication with both the extractors 16 and the buffer storage area 40. In this embodiment, the configurator 20 may be configured as described in the embodiment of FIG. 2, and may also allow users to configure the location to store buffered data, provide warehouse access information, and provide configurable schedules for the frequency of data loads from the buffer storage area 40 to the data warehouse 18. Additionally, the configurator 20 may provide an interface to the data warehouse 18 for performing in-warehouse transformations and data content filtering.

Finally, a data warehouse 18 may be provided in communication with the buffer storage area 40 to receive data transmitted to it. Similar to the embodiment of FIG. 2, the data warehouse 18 may comprise staging tables 29 configured to receive data transmitted from the appropriate buffer storage area 40. The data may then be stored in a physical data base 41 to allow companies the ability to analyze the data.

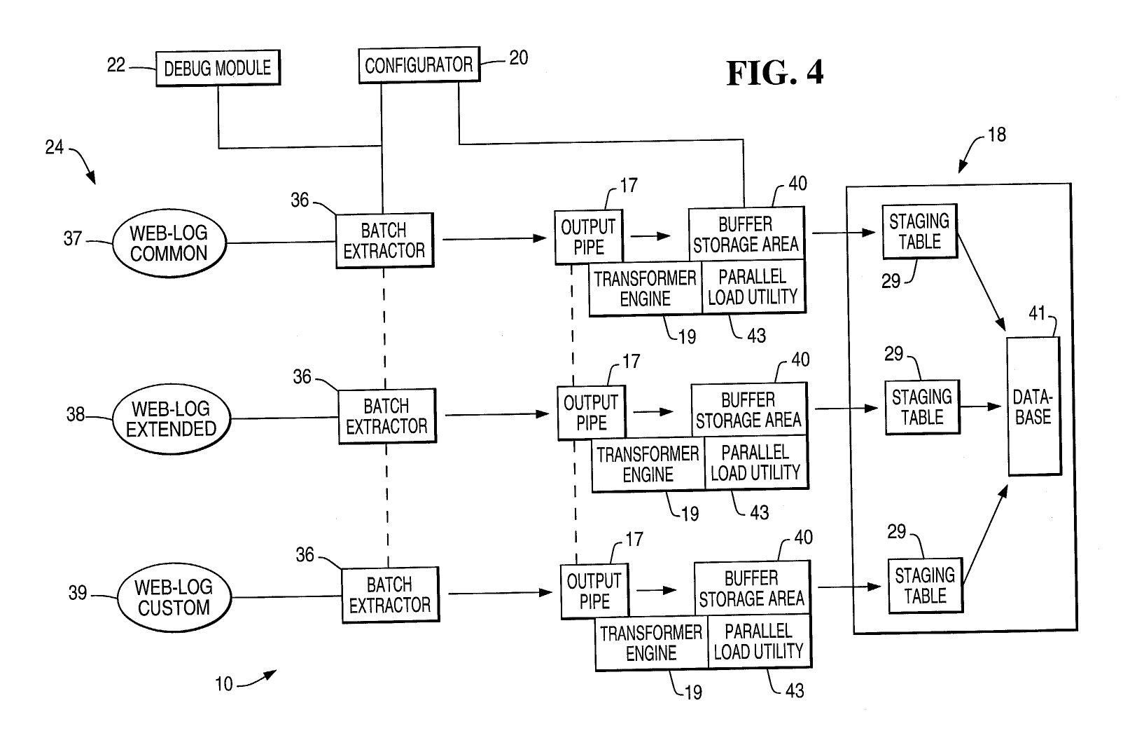

FIG. 4 depicts another exemplary embodiment an online data extraction system 10 in accordance with the present invention. In this embodiment of the invention, the data extraction system 10 is configured to extract online data in batch from flat files created by any variety of web-server and subsequently batch load the data into a data warehouse 18. As illustrated in FIG. 4, the data extraction system 10 may, comprise, a batch extractor 36 an output pipe 17, as well as a buffer storage area 40 and configurator 20. This embodiment of the invention is designed to allow businesses to collect large amounts of data from a variety of web-servers for analysis thereof.

As one of skill in the art may recognize, web-servers may be configured to generate flat files, such as log-files 24, with data relating to user activity with the web-server. In this embodiment of the invention, the data extraction system 10 may be configured to extract data from the various log-files in predetermined intervals and batch load the data into a data warehouse 18. The pre-determined intervals may be any interval, but in an exemplary embodiment of the invention, the pre-determined interval may range from about every 15 minutes to about once a day depending upon user configuration. Additionally, it should be recognized that the log files 24 created by the web servers may have various formats such as common 36, extended 37, custom 38 and many other types. The batch extractor 36 may be configured to extract data from any of these various web-log formats.

In an exemplary embodiment of the invention, the batch extractors 36 may be configured to run in parallel and be independent of each other so as not to impose any fixed limit on the number of batch extractors 36 that can be configured and run in a network environment. In the exemplary embodiment, the batch extractors 36 may be initially configured to run within a Microsoft Windows NT/2000 environment and support for UNIX flat files may later be accommodated.

A batch extractor 36 may be a set of instructions configured to support the integration of online data extracted from web-log files into a data warehouse 18. In particular, upon extracting online data from a log file 24, the system 10 may be configured to, among other things, filter, tag and transmit the data to a data warehouse 18 for analysis thereof. Once again, the data may be transmitted, utilizing the format of the host server 15 environment, to an output pipe 17 such as a named pipe/message queue 28 depending on the environment and source-supported technology. In this embodiment, the various host server 15 environment types may each have an assigned data format matching a staging table 29 format in the data warehouse 18.

Once the data is batch extracted from a log-file to an output pipe 17, the process of batch loading the data from the output pipe 17 to the data warehouse is the same as that previously described in with respect to FIG. 3. In sum, the output pipe 17 is serviced by a transformer engine 19 which transmits the data to an appropriate buffer storage area 40 and subsequently to a data warehouse 18. Once again, a parallel load utility 43, such as FastLoad may be utilized to transmit the data in batch to the appropriate staging tables 29 prior to being integrated into a physical database 41.

In this embodiment of the invention, the batch extractor 36 may also interface with a configurator 20. The configurator 20 may be configured as described in the embodiment of FIG. 3, and may also allow users to, among other things, specify the location of storage of buffered data from the batch extractor 36 or to specify the location and access method for data warehouse usage for the batch extractor 36.

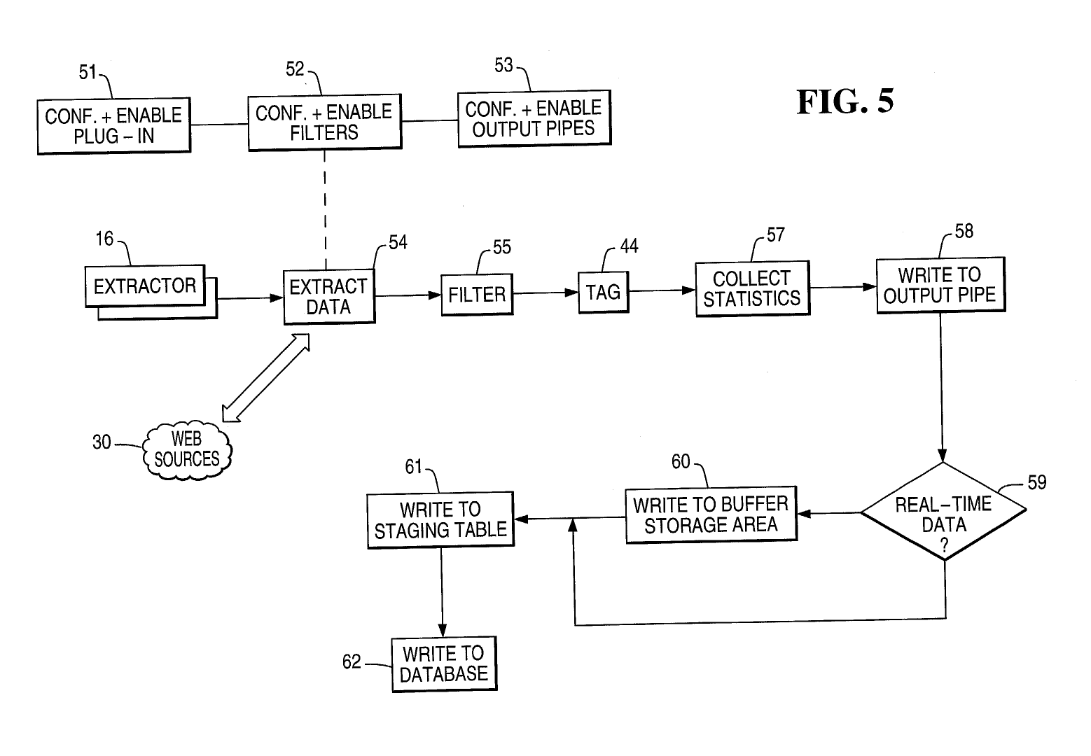

FIG. 5 illustrates an overview of data flow through the data extraction system 10. It should be recognized that regardless of whether the data extraction system 10 is configured for real-time or batch, the data flow through the system 10 varies only slightly. In particular, prior to extracting data, a user may desire to configured and enabled several components of the data extraction system 10. For example, the extractor 51, content filters 52 and output pipes 53 may be configured and enabled by a user. In an exemplary embodiment of the invention, a configurator 20 in communication with the system 10, may allow a user to configure and enable these components.

As previously described, an extractor 16 may be configured to extract data 54 from any variety of web-source 30. The extractor 30 may be configurable by the user to extract certain desired data from either a flat file generated by a web-server or data representing current user interaction with the system 10. The data can be filtered 55 upon extraction to allow the business entity collecting the data to keep only data deemed desirable and to minimize the amount of data that may otherwise be collected and stored in the data warehouse 18. The data may also be tagged 44 with a session ID for verification of the data and statistics on the data may be collected 57 before the data is written to an output pipe 58.

If the extracted is to be written to the data warehouse in real-time, the data may be transmitted directly to an appropriate staging table 61 via a continuous load utility. Conversely, if it is desirable to batch load the data to a data warehouse, the data may be transmitted to an appropriate buffer storage area 60 for temporary holding. The data, in this embodiment, may then be written to an appropriate staging table 61 at a pre-determined interval using a parallel load utility. After the data is written to an appropriate staging table it may be integrated into a physical data base 62 for analysis by the host entity. In this way, companies may be able to consistently capture and store online data in a data warehouse for the purpose of providing enhanced personalized offerings to users in communication with the company's web-site.

The foregoing descriptions of the exemplary embodiments of the invention have been presented for purposes of illustration and description only and should not be regarded as restrictive or limiting. They are not intended to be exhaustive or to limit the invention to the precise forms disclosed, and modifications and variations are possible and contemplated in light of the above teachings. While a number of exemplary and alternate embodiments, methods, systems, configurations, and potential applications have been described, it should be understood that many variations and alternatives could be utilized without departing from the scope of the invention. Moreover, although a variety of potential software and hardware components have been described, it should be understood that a number of other components could be utilized without departing from the scope of the invention. In addition, while various aspects of the invention have been described, these aspects need not be utilized in combination.

Thus, it should be understood that the embodiments and examples have been chosen and described only to best illustrate the principals of the invention and its practical applications to thereby enable one of ordinary skill in the art to best utilize the invention in various embodiments and with various modifications as are suited for particular uses contemplated. Accordingly, it is intended that the scope of the invention be defined by the claims appended hereto.

We claim:

1. A system for extracting data from a variety of web-sources, the system comprising:
an extractor plug-in comprising instructions configured to integrate with a plurality of pre-determined types of host servers and extract data in real-time from a plurality of types of web sources in communication with the host server; and
a transformer engine in communication with the extractor plug-in and configured to transmit the extracted data into a data warehouse for analysis thereof.

2. The system of claim 1, further comprising:
a configurator comprising instructions in communication with the extractor, the configurator operable to allow a user to configure parameters of the extractor for identifying data to be extracted.

3. The system of claim 1, wherein the host server comprises a web server.

4. The system of claim 1, further comprising:
an output pipe in communication with said extractor plug-in, wherein the data extracted from the web-source is transmitted to the output pipe utilizing the format of the pre-determined web-source.

5. The system of claim 4, wherein the output pipe comprises at least one of a named pipe and a message queue.

6. The system of claim 1, wherein the transformer engine comprises a continuous load utility.

7. The system of claim 1, wherein the transformer engine comprises a parallel load utility.

8. The system of claim 1, further comprising:
a buffer storage area in communication with the output pipe, the buffer storage area configured to temporarily store data transmitted from the output pipe before being transmitted to a data warehouse.

9. A system for extracting data from a variety of web-sources, the system comprising:
a batch extractor comprising instructions configured to integrate with a plurality of pre-determined types of host servers and extract data in batch from a plurality of types of web sources in communication with the host server; and
a transformer engine in communication with the extractor and configured to transmit the extracted data in batch into a data warehouse for analysis thereof.

10. The system of claim 9, further comprising:
a configurator comprising instructions in communication with the extractor-in, the configurator operable to allow a user to configure parameters of the batch extractor for identifying data to be extracted.

11. The system of claim 10, further comprising:
an output pipe in communication with said batch extractor, wherein the data extracted from the web-source is transmitted to the output pipe utilizing the format of the pre-determined web-source.

12. The system of claim 9, wherein the output pipe comprises one of the following: a named pipe and a message queue.

13. The system of claim 9, further comprising:
a buffer storage area in communication with said batch extractor configured to receive data.

14. The system of claim 9, wherein the transformer engine comprises a parallel load utility.

15. A method of extracting data from a variety of web-sources, the method comprising:
identifying a type of web source in communication with a host server;
selecting an extraction protocol based on the identified type of web source; and
executing the extraction protocol to extract data from the web source.

16. The method of claim 15, further comprising the step of:
transmitting the extracted data in real time to a data warehouse.

17. The method of claim 15, further comprising the step of:
transmitting the data in batch to a data warehouse.

18. The method of claim 15, further comprising the step of:
receiving extracted data in an output pipe utilizing the data format of the web source.

19. The method of claim 15, further comprising the step of:
temporarily storing extracted data in a buffer storage area before transmitting the data to a data warehouse.

20. The method of claim 15, further comprising the step of:
allowing a user to configure parameters identifying data to be extracted.
